(19) United States
(12) Patent Application Publication
(10) Pub. No.: US 2024/0383423 A1
(43) Pub. Date: Nov. 21, 2024

(54) PACKAGE-CARRYING ROBOT AND ITS CONTROL METHOD

(71) Applicant: TOYOTA JIDOSHA KABUSHIKI KAISHA, Aichi-ken (JP)

(72) Inventors: Hirotaka KOMURA, Tokyo-to (JP); Junya OTA, Tokyo-to (JP); Kenta MURAMOTO, Narashino-shi (JP); Shunta SHIMIZU, Tokyo-to (JP)

(73) Assignee: TOYOTA JIDOSHA KABUSHIKI KAISHA, Aichi-ken (JP)

(21) Appl. No.: 18/663,070

(22) Filed: May 14, 2024

(30) Foreign Application Priority Data
May 17, 2023 (JP) 2023-081275

(51) Int. Cl. G05D 1/656; F16K 24/04; G05D 105/28

(52) U.S. Cl. CPC B60R 16/08

(57) ABSTRACT

Drainage from a robot can be appropriately treated. A package-carrying robot includes: a water storage part in which water generated in a storage room in which a package is housed is accumulated; a drain part configured to drain the water accumulated in the water storage part; a traveling path state detection unit configured to detect a state of a traveling path of the package-carrying robot; and an open/close control unit configured to control opening/closing of the drain part according to the state of the traveling path of the package-carrying robot detected by the traveling path state detection unit.

### CROSS REFERENCE TO RELATED APPLICATIONS

This application is based upon and claims the benefit of priority from Japanese patent application No. 2023-081275, filed on May 17, 2023, the disclosure of which is incorporated herein in its entirety by reference.

### BACKGROUND

The present disclosure relates to a package-carrying robot that carries (i.e., transports) packages and its control method.

A mobile robot in which the interior of its vehicle body is divided into a waterproof section and a non-waterproof section, and drainage means is formed in the non-waterproof section has been known (see, e.g., Japanese Unexamined Patent Application Publication No. 2022-079386).

### SUMMARY

The above-described mobile robot sometimes drains water onto the floor of a building.

The present disclosure has been made to solve such a problem, and a main object thereof is to provide a package-carrying robot capable of appropriately treating drainage from itself, and its control method.

An aspect of the present disclosure for achieving the above-described object is a package-carrying robot including:
a water storage part in which water generated in a storage room in which a package is housed is accumulated;
a drain part configured to drain the water accumulated in the water storage part; a traveling path state detection unit configured to detect a state of a traveling path of the package-carrying robot; and
an open/close control unit configured to control opening/closing of the drain part according to the state of the traveling path of the package-carrying robot detected by the traveling path state detection unit.

In this aspect, the open/close control unit may open/close the drain part according to the state of the traveling path of the package-carrying robot and a state of the package or the water storage part.

In this aspect, when the open/close control unit determines that the package-carrying robot is traveling in a predetermined drainage space based on the state of the traveling path detected by the traveling path state detection unit, the open/close control unit may control the drain part into an opened state and drain the water accumulated in the water storage part to the drainage space.

In this aspect, the package-carrying robot further includes a water volume detection unit configured to detect a volume of the water accumulated in the water storage part, in which
when the open/close control unit determines that the volume of the water detected by the water volume detection unit is equal to or larger than a predetermined volume, the open/close control unit may control the drain part into an opened state and drain the water accumulated in the water storage part.

Another aspect of the present disclosure for achieving the above-described object is a method for controlling a package-carrying robot,
the package-carrying robot including:
a water storage part in which water generated in a storage room in which a package is housed is accumulated; and
a drain part configured to drain the water accumulated in the water storage part,
the method including:
detecting a state of a traveling path of the package-carrying robot; and
controlling opening/closing of the drain part according to the detected state of the traveling path of the package-carrying robot.

According to the present disclosure, it is possible to provide a package-carrying robot capable of appropriately treating drainage from itself, and its control method.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing a schematic configuration of a package-carrying robot according to an embodiment;

FIG. 2 is a block diagram showing a schematic system configuration of a control apparatus according to an embodiment;

FIG. 3 is a flowchart showing an example of a flow of a method for controlling a package-carrying robot according to an embodiment;

FIG. 4 is a block diagram showing a schematic system configuration of a control apparatus according to an embodiment; and

FIG. 5 is a flowchart showing an example of a flow of a method for controlling a package-carrying robot according to an embodiment.

### DESCRIPTION OF EMBODIMENTS

The present disclosure will be described hereinafter through embodiments, but the invention specified by the patent claims is not limited to the below-shown embodiments. Further, all the components/structures described in the embodiments are not necessarily indispensable as means for solving the problem. For clarifying the explanation, the following description and the drawings are partially omitted and simplified as appropriate. Note that the same reference numerals (or symbols) are assigned to the same elements throughout the drawings and redundant descriptions thereof are omitted as appropriate.

### First Embodiment

Embodiments according to the present disclosure will be described hereinafter with reference to the drawings. When a package-carrying robot stores a package such as a frozen product or a refrigerated product in its storage room and transports it, condensation occurs in the storage room and condensation water generated thereby is accumulated inside the package-carrying robot. In this case, the package-carrying robot needs to discharge the condensation water to the outside. However, the package-carrying robot may drain the water onto the floor of a building or the like, thus possibly causing a problem.

In contrast to this, a package-carrying robot according to this embodiment can properly treat drainage from itself by discharging it from itself in an appropriate place.

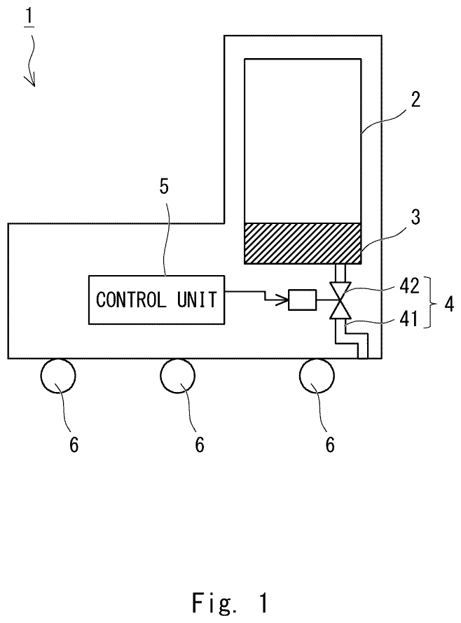

FIG. 1 is a schematic diagram showing a schematic configuration of the package-carrying robot according to this embodiment. The package-carrying robot 1 according to this embodiment includes a storage room 2, a water storage part 3 in which water generated in the storage room 2 is accumulated, a drain part 4 that drains the water accumulated in the water storage part 3, and a control unit 5.

The storage room 2 is a sealed space provided in the package-carrying robot 1, in which, for example, a package(s) such as a refrigerated product(s) or a frozen product(s) to be transported by the package-carrying robot 1 is stored. The storage room 2 may include, for example, vertically arranged shelves so that a plurality of packages can be placed on these shelves.

The water storage part 3 is configured as a tank in which water generated in the storage room 2, such as condensation water, can be accumulated. The water storage part 3 is provided below the storage room 2. They are configured so that condensation water and the like generated in the storage room 2 flows down from the storage room 2 to the water storage part 3.

The drain part 4 drains the water accumulated in the water storage part 3 to the outside. The drain part 4 includes a drainpipe 41 connected to the water storage part 3 and extending downward, and an open/close valve 42 provided in the drainpipe 41. The tip of the drainpipe 41 communicates with the outside, so that water is drained from the tip.

The tip of the drainpipe 41 is disposed on the rear side of a rear wheel(s) 6 of the package-carrying robot 1. Therefore, the drain part 4 is configured so as to drain the water accumulated in the water storage part 3 from the rear of the package-carrying robot 1 in a direction different from the traveling direction. In this way, it is possible to prevent the wheel 6 of the package-carrying robot 1 from being splashed with drainage, and thereby to prevent the wheel 6 from skidding. The open/close valve 42 is a solenoid valve or the like that opens/closes according to a control signal from the control unit 5.

The control unit 5 has a hardware configuration of an ordinary computer including, for example, a processor such as a CPU (Central Processing Unit) or a GPU (Graphics Processing Unit), an internal memory such as a RAM (Random Access Memory) or a ROM (Read Only Memory), a storage device such as a HDD (Hard Disk Drive) or an SSD (Solid State Drive), an input/output I/F for connecting peripheral devices such as a display, and a communication I/F for performing communication with external apparatuses.

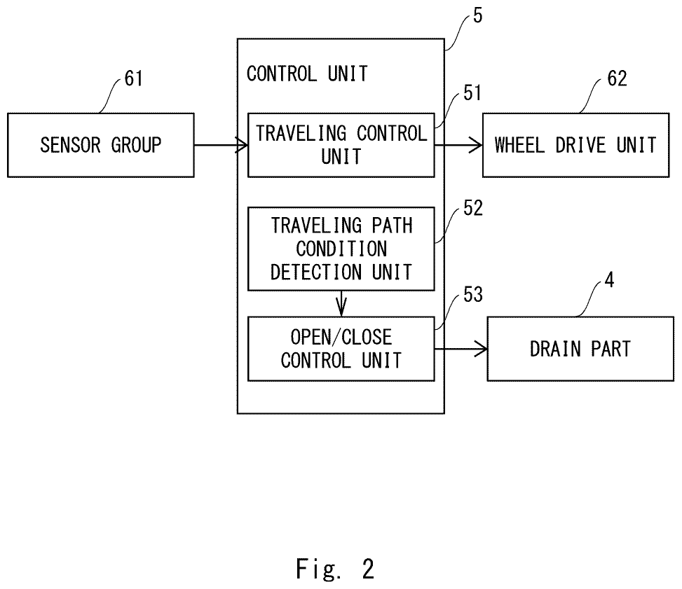

The control unit 5 controls the travelling of the package-carrying robot 1 and the drainage from the drain part 4. FIG. 2 is a block diagram showing a schematic system configuration of a control unit according to this embodiment. The control unit 5 according to this embodiment includes a traveling control unit 51, a traveling path state detection unit 52, and an open/close control unit 53.

A group of sensors (hereinafter also referred to as sensor group) 61 is connected to the traveling control unit 51. The sensor group 61 is a collective name of various sensors provided in the package-carrying robot 1. The sensor group 61 includes a range sensor for detecting distance information to an obstacle, a posture sensor for detecting posture information of the package-carrying robot 1, a rotation sensor for detecting rotation information of the wheel 6, and the like. The range sensor may be a camera, an ultrasonic sensor, or the like. The posture sensor may be an angle sensor or like. The rotation sensor may be a rotary encoder or like. The sensor group 61 supplies detected information to the traveling control unit 51.

A wheel drive unit 62 is connected to the traveling control unit 51. The wheel drive unit 62 includes a motor(s) for driving the wheel(s) 6, a motor driver(s) for driving the motor(s), and the like. The wheel drive unit 62 drives the wheel 6 under instructions from the traveling control unit 51.

The traveling control unit 51 controls the movement of the package-carrying robot 1 based on, for example, a moving path transmitted from a server or the like and distance information to an obstacle detected by the range sensor of the sensor group 61. The traveling control unit 51 controls the wheel drive unit 62 so that the package-carrying robot 1 moves according to the moving path transmitted from the server or the like while avoiding an obstacle based on distance information of the obstacle detected by the range sensor of the sensor group 61. In this way, the package-carrying robot 1 can autonomously move from a set starting point to a destination while avoiding obstacles.

The traveling path state detection unit 52 detects the state of the traveling path of the package-carrying robot 1. The traveling path state detection unit 52 detects (i.e., obtains), for example, an image of the traveling path taken by the camera of the sensor group 61 as the state of the traveling path. The traveling path state detection unit 52 outputs the detected state of the traveling path to the open/close control unit 53.

The open/close control unit 53 opens/closes the open/close valve 42 of the drain part 4 according to the state of the traveling path detected by the traveling path state detection unit 52. The open/close control unit 53 determines whether or not the package-carrying robot 1 is traveling in a predetermined drainage space based on the state of the traveling path detected by the traveling path state detection unit 52. The predetermined drainage space is a space in which it is acceptable to perform drainage, such as a side ditch and an outdoor area. The open/close control unit 53 can determine whether the package-carrying robot 1 is travelling in the predetermined drainage space by, for example, performing a pattern matching process on the image of the traveling path.

When the open/close control unit 53 determines that the package-carrying robot 1 is travelling in the predetermined drainage space based on the state of the traveling path detected by the traveling path state detection unit 52, it controls the open/close valve 42 of the drain part 4 into an opened state. The water accumulated in the water storage part 3 is drained to the drainage space through the drainpipe 41 and the open/close valve 42 of the drain part 4. In this way, it is possible to appropriately treat the drainage from the robot by discharging it to the appropriate drainage space.

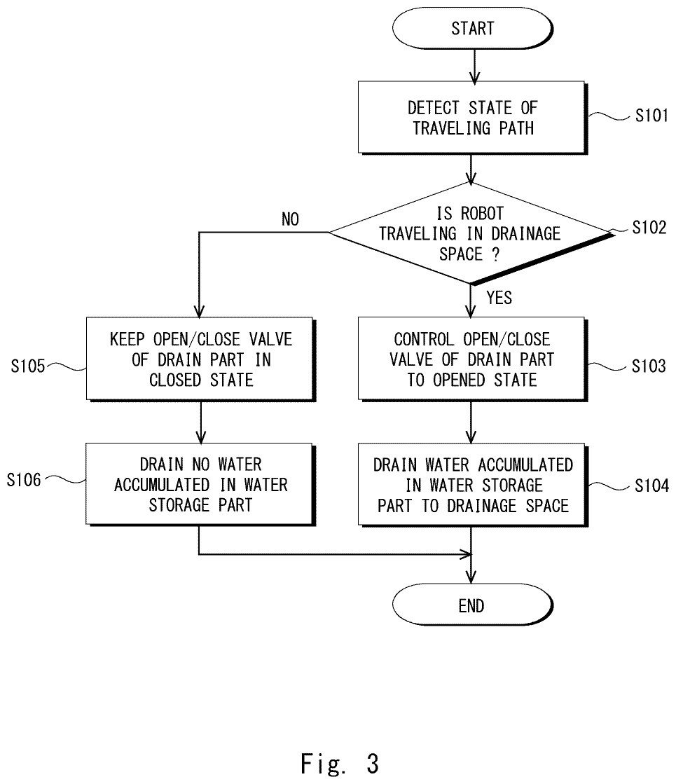

Next, a method for controlling the above-described package-carrying robot will be described with reference to FIG. 3. FIG. 3 is a flowchart showing an example of a flow of a method for controlling a package-carrying robot according to this embodiment.

The traveling path state detection unit 52 detects the state of the traveling path of the package-carrying robot 1 (Step S101).

The open/close control unit 53 determines whether or not the package-carrying robot 1 is traveling in a predetermined drainage space based on the state of the traveling path detected by the traveling path state detection unit 52 (Step S102).

When the open/close control unit 53 determines that the package-carrying robot 1 is traveling in the predetermined drainage space based on the state of the traveling path detected by the traveling path state detection unit 52 (Yes in Step S102), it controls the open/close valve 42 of the drain part 4 into an opened state (Step S103). As a result, the water accumulated in the water storage part 3 is drained to the appropriate drainage space through the drainpipe 41 and the open/close valve 42 of the drain part 4 (Step S104).

When the open/close control unit 53 determines that the package-carrying robot 1 is not travelling in the predetermined drainage space based on the state of the traveling path detected by the traveling path state detection unit 52 (No in Step S102), the open/close control unit 53 keeps the open/close valve 42 of the drain part 4 in a closed state (Step S105). As a result, the water accumulated in the water storage part 3 is not drained from the drain part 4 (Step S106).

### Second Embodiment

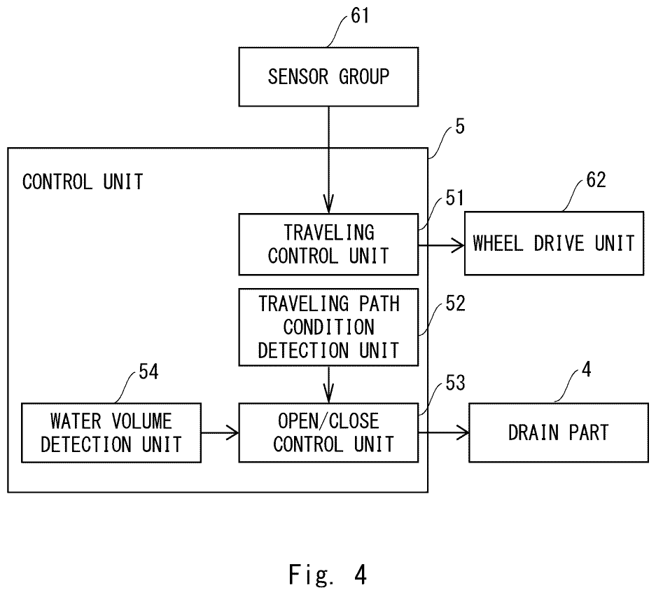

FIG. 4 is a block diagram showing a schematic system configuration of a control unit according to this embodiment. In this embodiment, the open/close control unit 53 of the control unit 5 opens/closes the open/close valve 42 of the drain part 4 according to the state of the traveling path of the package-carrying robot 1 and the state of the water storage part 3. The control unit 5 according to this embodiment further includes, in addition to the components/structures of the above-described embodiment, a water volume detection unit 54 that detects the volume of the water accumulated in the water storage part 3.

The water volume detection unit 54 can detect the volume of the water accumulated in the water storage part 3 based on a signal from a water volume sensor provided in the water storage part 3. Examples of water volume sensors include a level switch, a level meter, and the like.

When the open/close control unit 53 determines that the package-carrying robot 1 is traveling in a predetermined drainage space and the volume of the water detected by the water volume detection unit 54 is equal to or larger than a predetermined volume, it may control the open/close valve 42 of the drain part 4 into an opened state and thereby drain the water accumulated in the water storage part 3. In this way, it is possible to discharge the water accumulated in the water storage part 3 to an appropriate drainage space in a state in which the volume of the water accumulated in the water storage part 3 is equal to or larger than a certain volume, and hence to efficiently drain.

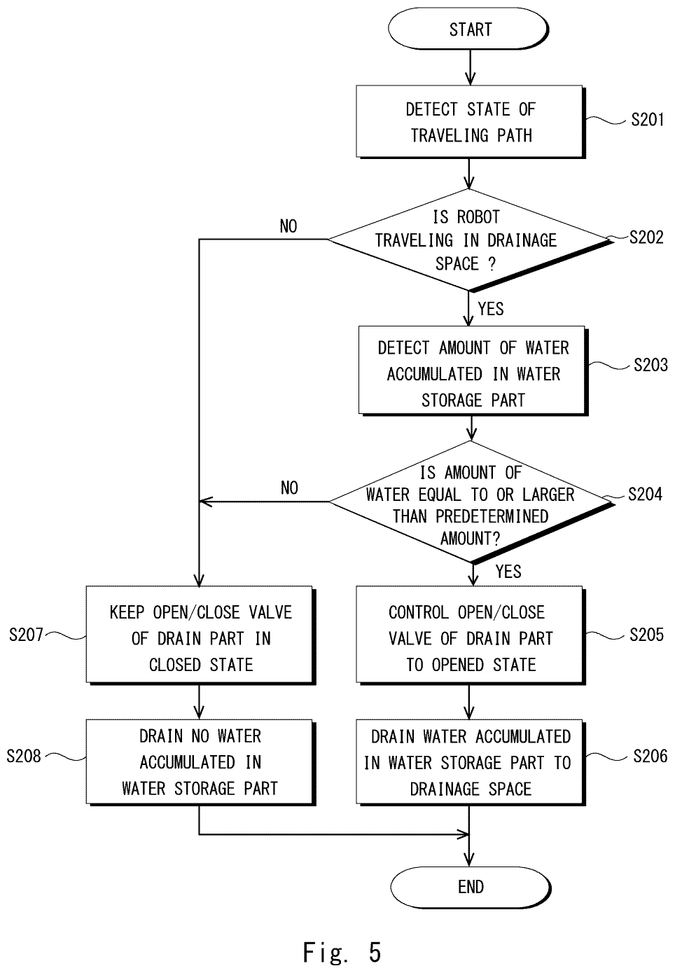

FIG. 5 is a flowchart showing an example of a flow of a method for controlling a package-carrying robot according to this embodiment.

The traveling path state detection unit 52 detects the state of the traveling path of the package-carrying robot 1 (Step S201).

The open/close control unit 53 determines whether or not the package-carrying robot 1 is traveling in a predetermined drainage space based on the state of the traveling path detected by the traveling path state detection unit 52 (Step S202).

When the open/close control unit 53 determines that the package-carrying robot 1 is traveling in the predetermined drainage space based on the state of the traveling path detected by the traveling path state detection unit 52 (Yes in Step S202), the water volume detection unit 54 detects the volume of the water accumulated in the water storage part 3 (Step S203). On the other hand, when the open/close control unit 53 determines that the package-carrying robot 1 is not traveling in the predetermined drainage space (No in Step S202), it proceeds to a process (in a step S207) (which will be described later).

The open/close control unit 53 determines whether the volume of water detected by the water volume detection unit 54 is equal to or larger than a predetermined volume (Step S204).

When the open/close control unit 53 determines that the volume of the water detected by the water volume detection unit 54 is equal to or larger than the predetermined volume (Yes in Step S204), it controls the open/close valve 42 of the drain part 4 into an opened state (Step S205) and thereby drains the water accumulated in the water storage part 3 to the predetermined drainage space (Step S206).

On the other hand, when the open/close control unit 53 determines that the volume of the water detected by the water volume detection unit 54 is not equal to or larger than the predetermined volume (No in Step S204), the open/close control unit 53 keeps the open/close valve 42 of the drain part 4 in a closed state (Step S207) and hence does not drain the water accumulated in the water storage part 3 (Step S208).

Further, the open/close control unit 53 may also open/close the open/close valve 42 of the drain part 4 according to the state of the traveling path of the package-carrying robot 1 and the state of the package. When the open/close control unit 53 determines that the package-carrying robot 1 is travelling in a predetermined drainage space and the package is, for example, a refrigerated product or a frozen product, it controls the open/close valve 42 of the drain part 4 into an opened state and thereby drains the water accumulated in the water storage part 3. In this way, it is possible to discharge the water to an appropriate drainage space after confirming that the package is likely to generate condensation water in the storage room 2.

Note that the open/close control unit 53 may infer that the package is a refrigerated product or a frozen product based on the temperature measured by a temperature sensor provided in the storage room 2 or the like.

The open/close control unit 53 may open/close the open/close valve 42 of the drain part 4 according to the state of the traveling path of the package-carrying robot 1 and the traveling time or the traveling distance.

When the open/close control unit 53 determines that the package-carrying robot 1 is traveling in a predetermined drainage space and the traveling time is longer than a predetermined time, it may control the open/close valve 42 of the drain part 4 into an opened state and thereby drain the water accumulated in the water storage part 3. Further, when the open/close control unit 53 determines that the package-carrying robot 1 is traveling in a predetermined drainage space and the traveling distance is longer than a predetermined distance, it may control the open/close valve 42 of the drain part 4 into an opened state and thereby drain the water accumulated in the water storage part 3.

When the package-carrying robot 1 has been traveling for a predetermined time or longer, or has travelled a predetermined distance or longer, it can be inferred that the volume of the water accumulated in the water storage part 3 is equal to or larger than a certain volume. Therefore, it is possible, after confirming that the volume of the water accumulated in the water storage part 3 is equal to or larger than the certain volume, to efficiently discharge the drainage to an appropriate drainage space.

Several embodiments according to the present disclosure have been described above. However, these embodiments are shown as examples but are not shown to limit the scope of the disclosure. These novel embodiments can be implemented in various forms. Further, their components/structures may be omitted, replaced, or modified without departing from the scope of the disclosure. These embodiments and their modifications are included in the scope of the disclosure, and included in the scope equivalent to the invention specified in the claims.

The present disclosure can also be implemented, for example, by carrying out the processes shown in FIG. 3 or 5 by having a processor execute a computer program(s).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, and RAM (Random Access Memory)).

The program may be provided to a computer using any type of transitory computer readable media. Examples of transitory computer readable media include electric signals, optical signals, and electromagnetic waves. Transitory computer readable media can provide the program to a computer through a wired communication line (e.g., electric wires, and optical fibers) or a wireless communication line.

Each of the components constituting the control unit 5 according to any of the above-described embodiments is, in addition to being able to be implemented by the program, able to be partially or entirely implemented by dedicated hardware such as an ASIC (Application Specific Integrated Circuit) or an FPGA (Field-Programmable Gate Array).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A package-carrying robot comprising:
a water storage part in which water generated in a storage room in which a package is housed is accumulated;
a drain part configured to drain the water accumulated in the water storage part;
a traveling path state detection unit configured to detect a state of a traveling path of the package-carrying robot; and
an open/close control unit configured to control opening/closing of the drain part according to the state of the traveling path of the package-carrying robot detected by the traveling path state detection unit.

2. The package-carrying robot according to claim 1, wherein the open/close control unit opens/closes the drain part according to the state of the traveling path of the package-carrying robot and a state of the package or the water storage part.

3. The package-carrying robot according to claim 1, wherein when the open/close control unit determines that the package-carrying robot is traveling in a predetermined drainage space based on the state of the traveling path detected by the traveling path state detection unit, the open/close control unit controls the drain part into an opened state and drains the water accumulated in the water storage part to the drainage space.

4. The package-carrying robot according to claim 2, further comprising a water volume detection unit configured to detect a volume of the water accumulated in the water storage part, wherein
when the open/close control unit determines that the volume of the water detected by the water volume detection unit is equal to or larger than a predetermined volume, the open/close control unit controls the drain part into an opened state and drains the water accumulated in the water storage part.

5. A method for controlling a package-carrying robot,
the package-carrying robot comprising:
a water storage part in which water generated in a storage room in which a package is housed is accumulated; and
a drain part configured to drain the water accumulated in the water storage part,
the method comprising:
detecting a state of a traveling path of the package-carrying robot; and
controlling opening/closing of the drain part according to the detected state of the traveling path of the package-carrying robot.
